(19) United States
(12) Patent Application Publication
(10) Pub. No.: US 2010/0304773 A1
(43) Pub. Date: Dec. 2, 2010

(54) METHOD FOR SELECTIVE ANTENNA ACTIVATION AND PER ANTENNA OR ANTENNA GROUP POWER ASSIGNMENTS IN COOPERATIVE SIGNALING WIRELESS MIMO SYSTEMS

(76) Inventor: Sean A. Ramprashad, Los Altos, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/786,285

(22) Filed: May 24, 2010

Related U.S. Application Data
(60) Provisional application No. 61/181,595, filed on May 27, 2009.

(51) Int. Cl. H04B 7/005

(52) U.S. Cl. 455/509; 455/522

(57) ABSTRACT

A method and apparatus is disclosed herein for selective antenna activation in cooperative signaling wireless systems. In one embodiment, the method is for use in a cooperative signaling MIMO system in which antennas are located a plurality of different locations across a geographic area, the system comprising a plurality of different cooperative MIMO controllers and a plurality of antennas that can be communicably coupled to each of the controllers, the method comprising: at different transmission instances, selectively activating one or more antennas in the cooperative signaling MIMO system to vary which subset of antennas are active among antennas that can be used for each of the controllers in the system, including applying a power pattern which specifies per antenna or per antenna group power assignments for the one or more antennas being selectively activated, and performing cooperative MIMO transmission under control of at each controller in conformance with antenna activation and antenna power assignments assigned for each transmission time.

### PRIORITY

The present patent application claims priority to and incorporates by reference the corresponding provisional patent application Ser. No. 61/181,595, titled, “A Method for Selective Antenna Activation and Per Antenna or Per Antenna Group Power Assignments in Cooperative Signaling Wireless MIMO Systems,” filed on May 27, 2009.

### FIELD OF THE INVENTION

Embodiments of the present invention relate to the field of Multiple Input Multiple Output (MIMO) wireless systems; more particularly, embodiments of the present invention relate to techniques where a number of coordinated/cooperative-signaling antennas are used to serve a coverage area containing multiple users.

### BACKGROUND OF THE INVENTION

In some wireless communication systems, groups of antennas (e.g., a number of antennas across a set of cooperative base-stations) cooperate in transmissions to jointly serve users contained within a coverage area. It is assumed that antennas belonging to different groups do not cooperate at the point of signaling, and that at times different groups may use the same transmission resource, e.g. the same frequency at the same time. Thus, different groups (of stations or antennas) generally interfere with each other over the wireless channel.

Interference is a common, well-known, inherent problem in many wireless transmission systems given the common broadcast nature of the wireless medium. Here different transmitters (different groups of antennas) share a common medium and if there are concurrent transmissions in time and frequency a user terminal will see not only its intended signal from its serving transmission site or sites, but signals (now forming interference) from transmitters serving other users. Interference can significantly limit the rates at which a user can be served.

To understand the detrimental effect of interference consider (roughly) the highest (achievable) rate with which a user or coverage area can be served. This upperbound rate can be modeled in-terms of a rough (upperbound) capacity of a system generally of the form, in bits/sec/Hz, of
(min(M,N)*(1/F))log 2(1+SINR)—for a single user MIMO (SU-MIMO) system
(M*(1/F)) log 2(1+SINR)—for a multi-user MIMO (MU-MIMO) system in which each user has a single N=1 receive antenna

For purposes herein, “M” is the number of transmitting antennas serving the users, “N” is the number of receive antennas on a user's terminal, “1/F” is the fraction of frequencies used (from the total) for serving users, “SINR” is the signal to interference noise ratio a user sees (for multi-user systems there are different SINRs for different users) which has a general form of

$$SINR = \frac{( Effective\_Signal \_Power )}{\begin{matrix}( Effective\_Noise \_Power ) + \\ ( Effective\_Interference \_Power )\end{matrix}}$$

Note, the above formulas are not precise in terms of every scenario. However, they do represent, for the purpose of the descriptions to follow, the trends in relation various common design factors. In particular, factors affecting system performance can be considered either as “pre-log” (i.e. before the log 2( )), e.g. “M”, “N” or “F”, or “log” (within the log 2( )) terms, e.g. terms related to SINR. The two types of terms combine to define roughly the rates with which each user may be served and with which a system may operate. The interplay between the two types of terms will become apparent below.

With zero interference, the SINR term can easily be 20, 30, . . . , 60 dB in many systems. Here the SINR term is actually a “signal to noise” term SNR.

$$SNR = \frac{( Effective\_Signal \_Power )}{( Effective\_Interference \_Power )}$$

Rates that a system can support are quite high in such an interference free case, e.g. log 2(1+SNR) for SNR=40 dB is about 13.3 bits/sec/Hz.

However, with non-zero interference the interference is often at a level determined by transmissions from non-cooperating stations (antennas). The interference level, assuming stations transmit independent messages, could in fact be the sum of all energy radiated over all interfering stations to the user, where the net signal strength seen at a user after a signal leaves a station is attenuated by pathloss and other effects as it propagates through the wireless medium. With this, the SINR term can easily be near 0 dB, or even negative in the dB domain. Note, even if the SNR is 40 dB, if the SINR is near 0 dB the rates in the presence of interference are on the order of log 2(1+1)=1 bit/sec/Hz, much less than 13 bits/sec/Hz.

As this shows, the supportable rate without interference can be significantly higher than that with interference, and ways to mitigate interference are of prime importance.

There are many proposed solutions to help mitigate interference, known to those familiar with the state of the art. In fact, the widely practiced idea of a cellular architecture controls interference by using the concept of frequency reuse. Here transmitting base-stations (BSs) that use the same frequency, and thus interfere with each other, are also arranged to be geographically separated in space. For example, in an ideal two-dimensional hexagonal topology one can insure that two adjacent cells do not use the same frequency. This can be done by using at a minimum 3 groups of frequencies and assigning them as in FIG. 1. This is a frequency reuse factor 3 system. This has the effect of making the term “1/F” in the above calculations be 1/F=1/3.

Moving the interference further away in geographic spacing does lower interference, e.g. doubling distance lowers the level by a factor of (1/2)^{a}. Here “a” is the pathloss exponent, often between 2 and 4. A factor of a=3 results in a reduction by 1/8, a 9 dB reduction. Thus, interference is reduced, but not eliminated, and the SINR increases

Higher frequency reuse factors can be used to further geographically separate interfering stations. This leverages further the increased pathloss and propagation loss so as to ensure that the interference and SINR a user sees can be reasonable on some frequency.

FIG. 2 illustrates a reuse 2 system as in a 1 dimensional model, which is a simple illustration of the same concept of FIG. 1. Such one dimensional models are convenient for the purpose of illustrating ideas herein, and do not limit or present consideration of ideas in 2 dimensional topologies.

The use of frequency reuse, however, to reduce interference comes at the expense of efficiency in terms of the term “(1/F)”, as seen directly as a pre-log term in the capacity formula. The pre-log term has a very direct and strong effect on the throughput a system can support.

In the example of FIG. 1, the value 1/F=1/3. Therefore, by nature, the frequency reuse concept increases the log 2(1+SINR) term, but decreases the per-log scaling. Sometimes there is a net-gain in doing so, but often (and in more advanced systems) the preference is to keep the “(1/F)” factor as large (close to 1) as possible.

One way to do so is to use fractional frequency reuse. In fractional frequency reuse (FFR), a station is able to use all frequencies. However, there is an unequal power split between bands. Effectively, the “(1/F)” term is increased, but not fully one. As an example, consider the 1-dimensional illustration (for simplicity) in FIG. 3. (Note, 2 dimensional versions of FFR follow.) This example uses two frequencies and alternates the power allocation to different stations. The “High” and “Low” powers are such that they average to a “Nominal” value, i.e.

½ High+½ Low=Nominal

For example, if the Nominal level is 1 (0 dB), and High is 1.8 and Low is 0.2, then an average power for all clusters is 1 per BS per Hz.

Concepts of frequency reuse and fractional frequency reuse can also be illustrated in tables of transmission power. Consider again 1 dimensional models for convenience, noting that this does not preclude consideration of ideas in 2 dimensions. In Table 1 below, a “nominal” signal level is used by all stations on all frequencies, and we have a frequency reuse F=1 system. Of course, this means that some users, like user(b) in FIG. 3 at the edge of a cell, will see an SINR on the order of 0 dB.

TABLE 1
Frequency Reuse Factor 1 power assignment

| Basestation | 1 | 2 | 3 | 4 | . . . | 10 |
|---|---|---|---|---|---|---|
| Level on | Nominal | Nominal | Nominal | Nominal | . . . | Nominal |
| frequency 1 | | | | | | |
| Level on | Nominal | Nominal | Nominal | Nominal | . . . | Nominal |
| frequency 2 | | | | | | |

In Table 2 below, a frequency reuse 2 system, 1/F=1/2, is shown. Here the interference is reduced given the increased geographic separation between stations. Essentially, this is a system where “Low”=0, and stations when “High” transmit at “High=2×Nominal”.

TABLE 2
A Frequency Reuse Factor 2 power assignment

| Basestation | 1 | 2 | 3 | 4 | . . . | 10 |
|---|---|---|---|---|---|---|
| Level on | 2 × Nominal | 0 | 2 × Nominal | 0 | . . . | 2 × Nominal |
| frequency 1 | | | | | | |
| Level on | 0 | 2 × Nominal | 0 | 2 × Nominal | . . . | 0 |
| frequency 2 | | | | | | |

In Table 3 below, the power on each frequency is alternated between a two non-zero “High” and “Low” values. This allows odd numbered stations to have a favorable SINR at the cell edge on frequency 1, and even numbered stations to have a favorable SINR at the cell edge on frequency 2. All stations however can use all frequencies, and the result is that this “Fractional Frequency Reuse” system often can have better tradeoffs than either the reuse 1 or reuse 2 systems.

TABLE 3
Fractional Frequency Reuse power assignment

| Basestation | 1 | 2 | 3 | 4 | . . . | 10 |
|---|---|---|---|---|---|---|
| Level on | High | Low | High | Low | . . . | Low |
| frequency 1 | | | | | | |
| Level on | Low | High | Low | High | . . . | High |
| frequency 2 | | | | | | |

The frequency reuse systems can however only do so much to control interference and create rate benefits. The extreme effect due to the effect of the pre-log “1/F” term shows why this is the case; controlling interference only improves the terms within log 2( ) which have show large benefits in SINR terms in order to justify decreases in pre-log terms.

One way to improve performance beyond a cellular system is a cluster (cooperative signaling) approach, known to those familiar with the state of the art. To illustrate this concept, FIG. 4 shows a case of C=3 stations/cluster and M=3 antennas/station. In such a system, groups of C (C=3 in FIG. 4) stations coordinate their transmissions. Assume there are M antennas per base-station. In the extreme the joint group of CM antennas, across the C stations, signal jointly to users across the C cells within a cluster. This can be done in a way that interference seen by any user in the cluster, by transmissions to other users from stations within the cluster, can be set either to zero, or some acceptable (good) level. Such interference is termed “Intra-Cluster Interference”. The signaling underlying such a system is often a Multi-User MIMO (MU-MIMO) system, known to those familiar with the state of the art. MU-MIMO techniques such as Zero Forced Linear Beamforming (ZFLB) are able set the Intra-Cluster Interference from base-stations within the cluster to users in the cluster to zero.

The cluster approach effectively removes (C-1) cell edges in the system, reducing the total interference seen by any user. Now only inter-cluster interference remains, and is mainly a problem at cluster edges, not all cell edges. With this, the system performance can be greatly enhanced over a cellular system even using frequency reuse factor 1, where 1/F=1.

The system also, for users in the center of a cluster, moves the effective worst-case interfering stations further way in distance. The effective distance in a reuse 1 system from the center to the closest interfering station is about C/2 cell separations away, not just 1 cell separation. Thus interference at the center of the cluster, and even the edge, can be reduced since many interfering stations are now pushed further way in space. However, this system still has edges, albeit fewer cluster edges.

An extension to this idea is the use of overlapped clusters. This is illustrated for the case of using C=3, M=3 antennas/station, and three frequency bands in FIG. 5. Note the overlaps in coordination can happen in time, frequency, or a combination of as described in G. Caire, et al., “Multiuser MIMO downlink with limited inter-cell cooperation: Approximate interference alignment in time, frequency and space,” in Proc. 46th Allerton Conf. Commun., Control and Computing, Monticello, Ill., October 2008. For convenience, this is described herein in terms of frequencies. In G. Caire, et al., “Multiuser MIMO downlink with limited inter-cell cooperation: Approximate interference alignment in time, frequency and space,” in Proc. 46th Allerton Conf. Commun., Control and Computing, Monticello, Ill., October 2008, it is described in terms of periodic patterns in time.

The system as illustrated in FIG. 5 can still be a frequency reuse factor 1 system, just that different frequencies see different cluster edges. The idea is that each user has at least one frequency (coordination pattern, which could also exist on some times) for which is sees a favorable interference level, i.e. one channel resource for which it is far from the cluster edge on that resource.

When combined with scheduling, the system can greatly improve performance over FIG. 4 by ensuring that users are only served when (on what time) and on what frequencies are best.

Table 1 to Table 3 can be generalized to cluster arrangements whereby different stations in a cluster can see different power levels. For example, Table 4 below shows a power assignment for FIG. 4 in which the center station of a cluster is always high (it is not the same as simply translating Table 3 to a cluster system).

TABLE 4
Example of a power mask in the cluster coordinated case as applied to FIG. 4

| | Cluster | | | | | | |
|---|---|---|---|---|---|---|---|
| | CLUSTER 1 | | | CLUSTER 2 | | | |
| Basestation | 1 | 2 | 3 | 4 | 5 | 6 | . . . |
| Level on | High2 | High2 | High2 | Low2 | High2 | Low2 | . . . |
| frequency 1 | | | | | | | |
| Level on | Low2 | High2 | Low2 | High2 | High2 | High2 | . . . |
| frequency 2 | | | | | | | |

This can improve performance for the cluster cooperative case.

Note, here the high value is not the same as the “High” in cellular systems. Rather it is another “High2” value. Similarly, the low value is a new “Low2” value. Both are chosen so that, over the cluster, the average power per BS per Hz is the “Nominal” level. For in Table 4, this could mean that

2×Low2+4×High2=6×Nominal

This can improve cluster based systems.

While certainly useful there is, however, one drawback in doing a cluster based approach and power mask in the way described. Specifically the power mask controls interference by simply changing the power over an existing set of antennas.

In the case of frequency 2 of cluster 1 in Table 4 and FIG. 4, it means that the M antennas of each of stations 1 and 3 (at the C=3 cluster edge) are operating at a low level (see Table 4). Thus, the capacity these stations are adding to the system in terms of bits/sec/Hz are uniformly reduced over each (and all) of these “M” antennas.

Another way to understand this effect is to note that the lower power has to be divided up among the effective eigenmodes of the system (the number of modes=the number of antennas), and thus divided up among the users served by the antennas. This may not be the best way to use a pool of transmission power across frequencies, antennas and coordination patterns.

Another technology option to note is the possibility of a Distributed Antenna System (DAS). Such prior art does consider geographically distributing antennas in a regular or irregular pattern across a coverage area as in FIG. 6. Again, a 1 dimensional model is used for simplicity. In such systems, the active antenna pattern is static. DAS systems can also be described in tables. A static DAS system, as described in FIG. 6 and Table 5 below, may not be as effective as a cluster system as in FIG. 4 or FIG. 5 because the DAS system also can see increases in interference near cell edges despite allowing servicing antennas to be brought nearer to users. Such a tradeoff can be detrimental for cell edge users, and these users need to be served. Note, as in the frequency reuse case and the factor “1/F”, antenna activation in a local area is modeled through the “M” which is also a pre-log factor in capacity.

TABLE 5
A variable antenna system DAS which is static

Cluster

| | CLUSTER 1 | | | CLUSTER 2 | | | |
|---|---|---|---|---|---|---|---|
| Basestation | 1 | 2 | 3 | 4 | 5 | 6 | . . . |
| All | 1 | 7 | 1 | 1 | 7 | 1 | . . . |
| frequencies | | | | | | | |

### SUMMARY OF THE INVENTION

A method and apparatus is disclosed herein for selective antenna activation in cooperative signaling wireless systems. In one embodiment, the method is for use in a cooperative signaling MIMO system in which antennas are located a plurality of different locations across a geographic area, the system comprising a plurality of different cooperative MIMO controllers and a plurality of antennas that can be communicably coupled to each of the controllers, the method comprising: at different transmission instances, selectively activating one or more antennas in the cooperative signaling MIMO system to vary which subset of antennas are active antennas among antennas that can be used for each of the controllers in the system, including applying a power pattern which specifies per antenna or per antenna group power assignments for the one or more antennas being selectively activated, and performing cooperative MIMO transmission under control of each controller in conformance with antenna activation and antenna power assignments assigned for each transmission time.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates classic frequency reuse factor 3 system (2 dimensions).

FIG. 2 illustrates classic frequency reuse factor 2 system (1 dimension).

FIG. 3 illustrates fractional frequency reuse 2 in 1-dimension.

FIG. 4 illustrates a cluster coordinated system where adjacent C=3 stations cooperate/coordinate in transmission.

FIG. 5 illustrates an overlapped cluster coordinated system using 3 patterns over 3 groups of frequencies.

FIG. 6 illustrates a distributed antenna system where a static antenna deployment and static activation pattern exists over different antenna locations (or stations).

FIG. 7 illustrates a variable activated (dynamic) antenna system illustrated using two frequencies wherein the pattern changes from frequency to frequency.

FIG. 8 illustrates one mode of operation where the variable-activated antenna system is combined with shifts in the coordination.

FIG. 9 illustrates (some) representative users on one antenna pattern on one frequency.

FIG. 10 is a flow chart of one embodiment of a process for variable allocating active antennas.

FIGS. 11A, 11B and 11C illustrate techniques by which a controller can drive a group of antennas.

FIG. 12 is a system level flow chart, operating across all clusters, describing one embodiment of the process occurring across the topology of multiple clusters in time and frequency.

### DETAILED DESCRIPTION OF THE PRESENT INVENTION

Embodiments of the invention include a method by which antennas distributed across a geographic area are selectively activated across frequency and/or time, with a specified power to each antenna when active as a function of frequency and/or time, in order to achieve an improved balance of resources of such power and antennas, thereby allowing the system to improve wireless efficiency. In one embodiment, the antennas that are activated, and the power per antenna, changes with time and/or frequency in a purposeful and advantageous way that balances the benefits of interference mitigation to the service needs of different users. Specifically, sometimes users are given an advantage at the expense of other users, and sometimes those same users are put at a disadvantage to the benefit of other users. By matching power correctly to the number of antennas and interference levels, a better use of the wireless resource can be obtained. The net result is often net benefit to all users. Often the benefits are seen by improving the within log 2( ) factors with little or no loss to the pre-log 2( ) factors.

This change in antenna activation can be either pre-determined within each antenna control device, or adaptively controlled by a central or distributed set of system elements, in a way that they occur over time and/or frequency. A good balance in such changes enables the system to provide for each user, on some time and/or frequency slot, a favorable channel. In addition, by matching power resources to the number of antennas, as previously described by considering the general effects of different pre-log( ) and within log( ) terms, a good balance of antenna and power over time/ and/or frequency can be achieved (e.g. finding reasonable balances of both pre-log and log terms in the capacity). The variable activation of antennas in particular allows the system to best match transmission power at a site (station) to a number of active antennas at that site. In a rough sense, the power should be roughly proportional to the number of antennas, implying a fixed power per antenna. But depending on other terms within log( ) factors that determine supportable user rates one can have non-uniform power per antenna allocations that can improve the general performance.

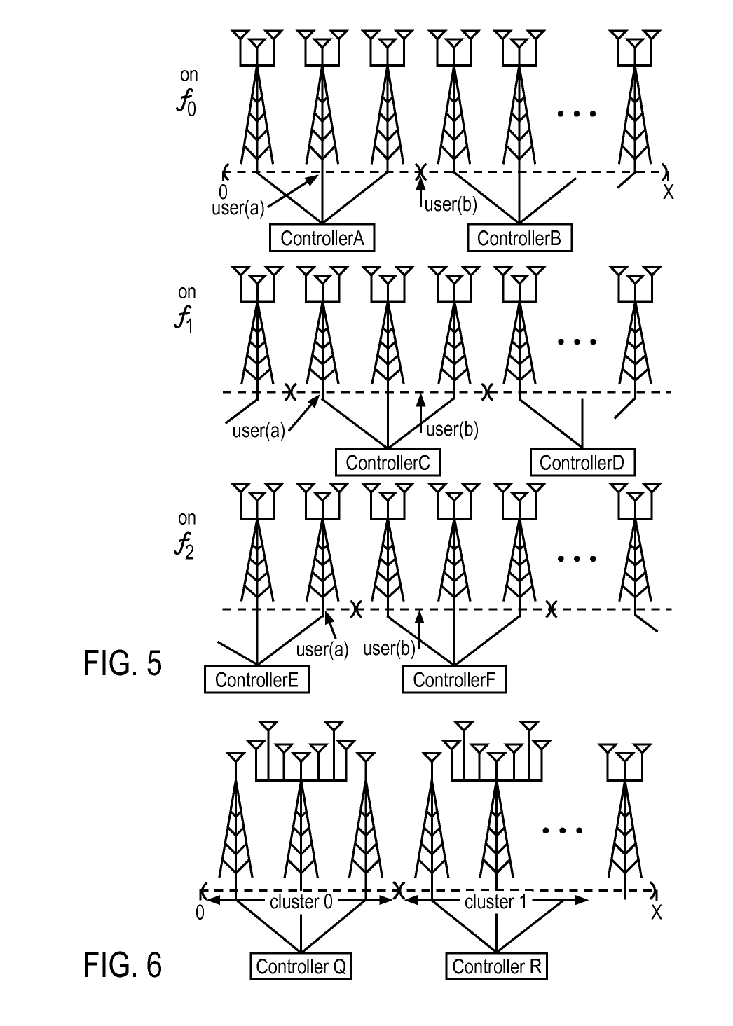

The variable activation and additional power per antenna changes allows for better use of the total transmission (power) resources compared to the case in which the number of active antennas per site on any time/frequency slot is static (remains fixed). In other words, a static system, with a fixed activation pattern of antennas common to all times and frequencies as in a cluster system or a DAS system (illustrated in FIG. 4, FIG. 5 and FIG. 6), even with power masks, is not as efficient as a system that is able to selectively activate antennas.

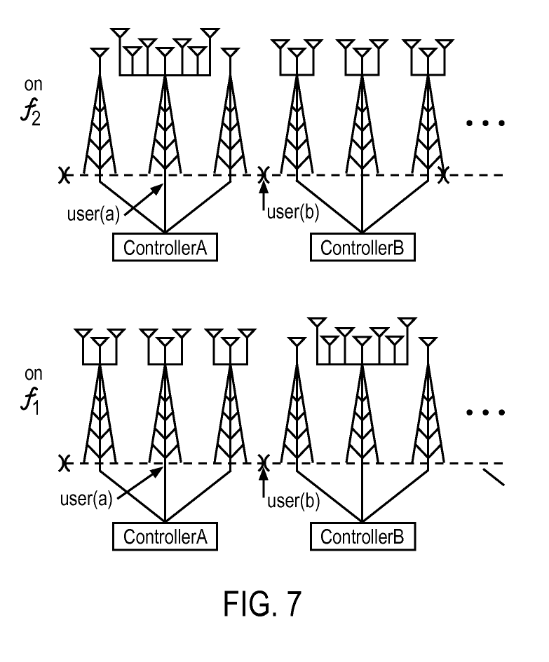

Embodiments of the invention assume that base-stations (or antenna locations) have a pool of antennas which can be used to create such patterns. In general, for this operation, a station would have more available antennas at its disposal than in a static system; in a static system, the number of antennas that are active is fixed. In a variable antenna system on some time and/or frequency slots, a station in the system may have more or less active antennas than in a static system. At such times and/or frequencies, inactive antennas are simply powered off or driven by zero input signals. However, per frequency and/or per time slot, the variable antenna system can be made to operate with no more active antennas on average than the static system. For example, the system in FIG. 7 has the same number of active antennas per Hz per cluster as FIG. 4, FIG. 5 and FIG. 6. In fact, the benefits in terms of transmission efficiency seen in variable activation systems in fact allows systems to use fewer active antennas per Hz than prior art systems, yet achieve similar or better performance than such systems. This can have further power benefits and benefits in system overheads, such as the number of channel pilots a system needs.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

One innovation described herein is the use of a variable, purposeful, carefully selected, pattern of active antennas across base-stations or antenna locations. The pattern is varied in a known fashion over time and/or frequency, or over any unit of transmission resources. In one embodiment, associated with this pattern can also be a pattern of powers per antenna within each pattern.

In one embodiment, patterns are purposefully chosen to achieve two main effects: balancing of interference between clusters of coordinated base-stations or coordinated antennas; and matching a base-station radiated power level on a time and/or frequency slot efficiently to the number of antennas active on that time/frequency, and vice-versa. The match can be made to try to achieve a large value in the net wireless capacity functions which operate locally at each area of a geographic area. Each of such power and antenna values balance power terms, which end up as within log( ) factors in capacity, to pre-log terms such as the number of antennas.

The implementation can be straight-forward. Each station would have a controller to selectively and effectively activate or deactivate each antenna on a given frequency or frequencies. Deactivating an antenna can be done by driving the antenna with a zero-input signal, or by shutting down the antenna entirely. In one embodiment, each station is equipped with sufficient numbers of antennas to conform to the operation defined by the activation pattern over all times and frequencies. Conversely, patterns are chosen to conform to the number of potentially available antennas on each station.

In one embodiment, the operation is specified by a table that describes when or on what frequencies and/or times antennas are to be active. There can also be a table saying how much power can be used at each antenna on each time and/or frequency.

In one embodiment, implemented power assignments may conform to a sum power constraint. For example, if there are M1=3 antennas, and we want P1 power per antenna on average on these antennas, the system may choose to ensure that the group of M1=3 antennas conforms to not radiating more than M1×P1 power across them (at the specified time or frequency).

Beyond this, for any given configuration of the system on a given time or frequency slot, the physical layer can operate as it would for any antenna pattern, or any static or existing system. Such operation, given the above setup, would be apparent to those skilled in the art. The only changes would be that the system, knowing that such changes exist, can be more selective on which users it decided to serve on different time and or frequency slots.

The following describes how one should choose the activation pattern and power patterns in an effective way, as well as how to do so for each of the two effects described above.

### First Effect

The first effect is achieved by having complementary activation patterns, where each pattern describes the numbers and locations of active antennas. The patterns are created and are assigned in such a way that each cluster of station sees each pattern over time and/or frequency in a regular fashion. For example, in Table 6 below there are two patterns, each of which applies to a cluster of three stations:

Pattern 1=[1, 7, 1] active antennas

Pattern 2=[3, 3, 3] active antennas

The first pattern concentrates signal power and antenna activation (and thus capacity) in the center of the cluster. This also has the goal of reducing the interference a cluster using such a pattern may have on (radiate to) an adjacent cluster. The second pattern tries to improve the signal energy and antenna distribution across the cluster. However, by putting more resources on the edge of a cluster, a cluster using such a pattern would potentially radiate more interference into an adjacent cluster. Thus by using Pattern 1 the system intends to influence the interference term (in the SINRs) seen by users in other clusters, and by using Pattern 2 the system intends to influence the signal term (in the SINRs) seen by users in its own cluster.

TABLE 6
A variable antenna activated system
which changes across frequency

Cluster

| | CLUSTER 1 | | | CLUSTER 2 | | | |
|---|---|---|---|---|---|---|---|
| Basestation | 1 | 2 | 3 | 4 | 5 | 6 | . . . |
| Number of active | 3 | 3 | 3 | 1 | 7 | 1 | . . . |
| antennas on | | | | | | | |
| frequency 1 | | | | | | | |
| Number of active | 1 | 7 | 1 | 3 | 3 | 3 | . . . |
| antennas on | | | | | | | |
| frequency 2 | | | | | | | |

In a 1-dimensional layout of clusters, a good way to achieve a good interference balance for some clusters, and good signal distribution for other clusters, is to alternate the patterns as in Table 6 above, with even numbered clusters getting Pattern 2 and odd numbered clusters getting Pattern 1. But this is not sufficient since it will result in a skew in the performance of odd versus even clusters.

One way to allow for a fair balance in the system, i.e. to allow both a good interference balance for all clusters, and good signal distribution for all clusters, is to use the converse assignment on another time or frequency slot, with even numbered clusters getting Pattern 1 and odd numbered clusters getting Pattern 2. This is shown in Table 6 above whereby the pattern changes over frequency in a regular (complementary) fashion.

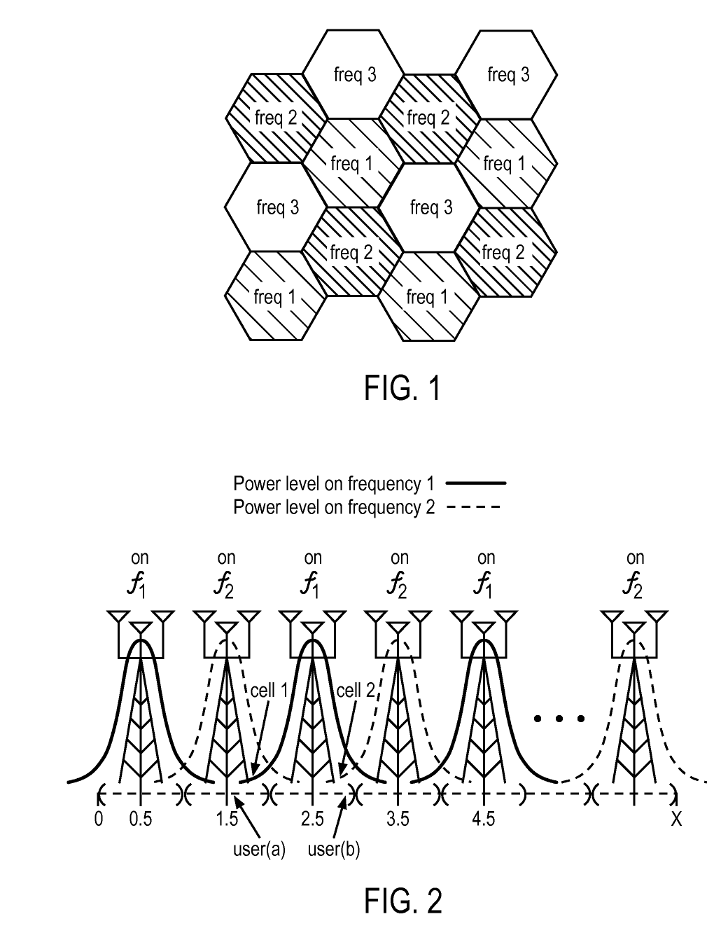

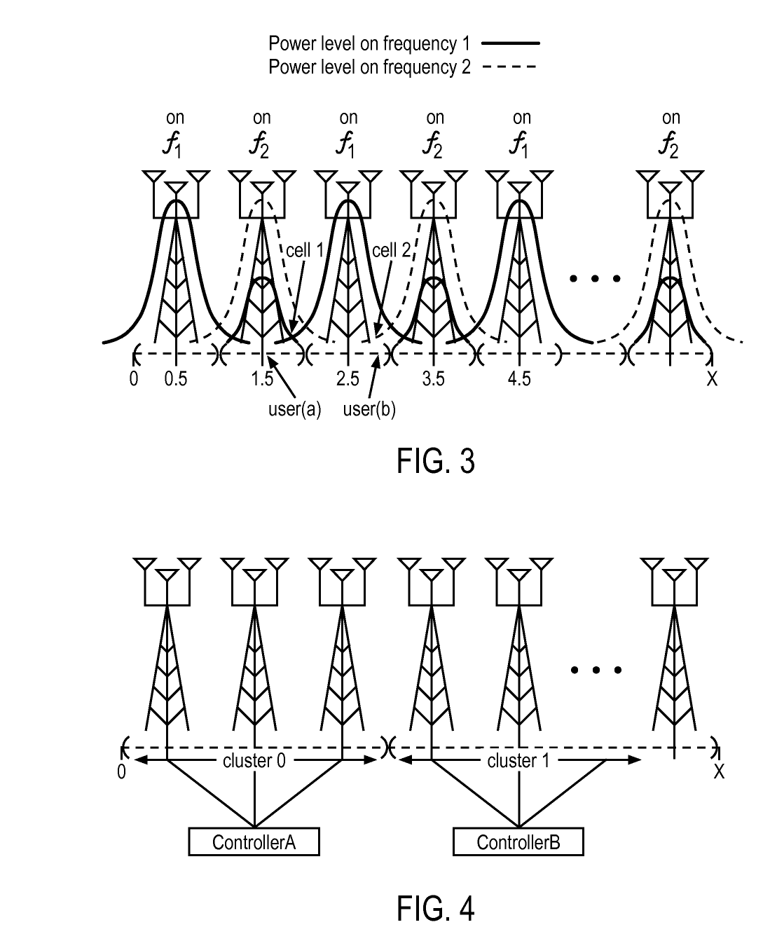

For two-dimensional topologies, counterparts of patterns and assignments based on this principle would be apparent to those skilled in the art. For example, for 2-D, one could use three base patterns and assign them to 2-D clusters in patterns similar to a frequency reuse 3 pattern of FIG. 1 (but where cells are say replaced by cooperative clusters of C=7 cells).

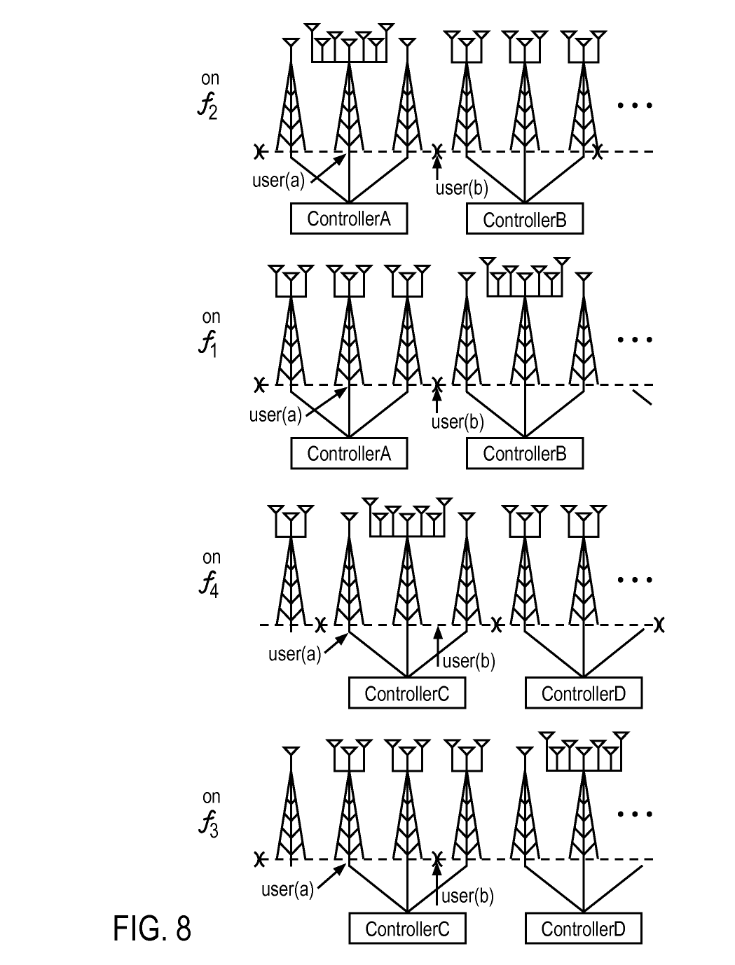

In another embodiment of the invention, the variable antenna activation is combined with the overlapped cluster strategy of FIG. 5. This overlapped strategy is described in U.S. patent application Ser. No. 12/538,729, entitled “A Variable Coordination Pattern Approach for Improving Performance in Multi-Cell or Multi-Antenna Environments,” filed Aug. 10, 2009. The combination of both approaches is shown in FIG. 8. This allows for the joint benefit of both approaches, whereby not just clusters, but local areas around each base-station, see effectively all patterns. Here each “controller” in the system can be implement its given pattern on a given frequency. A subset of such “controllers” may also be part of a single entity, and thus will control and coordinate different antennas on different times and/or frequencies as required.

Again, while described in terms of frequency assignments, all such embodiments can be generalized to assignments patterns across time, and or across time and frequency. Such embodiments can be generalized to patterns which exist across any units of “transmission resource”. Embodiments can also be generalized to the C=1 case, where a pattern of active antennas is simply a single number stating the number of active antennas on that station for a transmission resource.

### Second Effect

Implicit in the above logic (successful operation of the system) is the assumption that when there are less active antennas on a station, there is less radiated power from that station and thus less radiated interference to other cluster or cells that do not jointly signal with that station.

Such an assumption is true for example in the case the system has a fixed power allocation per active antenna per frequency (or per time). For example, if on a frequency (e.g. frequency 1), there are M=5 active antennas on a station, and on another frequency (e.g. frequency 2) the same station uses M=1 active antennas, the result would be that the station radiates 5-times as much power on frequency 1 as on frequency 2.

But this does not need to be the case, though the above strategy does work quite well, as forms one of the embodiments. This is shown in the analysis below.

Another embodiment has in addition to the number of active antennas, a relative power per antenna assignment for each antenna on each pattern. One such example is described in Table 7 below. Here when using pattern

[1,7,1] active antennas

the (relative) power allocations is

[½, 8/7, ½].

This means that the middle 7 antennas are using proportionally more power per antenna than the two cluster edge antennas. Another example would be to use a power allocation

[2, 5/7, 2].

This means that the middle 7 antennas are using proportionally less power per antenna than the two cluster edge antennas.

TABLE 7
A joint power and antenna assignment that changes with frequency

| | Cluster | | | | | | |
|---|---|---|---|---|---|---|---|
| | CLUSTER 1 | | | CLUSTER 2 | | | |
| Basestation | 1 | 2 | 3 | 4 | 5 | 6 | . . . |
| Number of active | 3 at | 3 at | 3 at | 1 at | 7 at | 1 at | . . . |
| antennas on | relative | relative | relative | relative | relative | relative | |
| frequency 1 | power 1 | power 1 | power 1 | power ½ | power 8/7 | power ½ | |
| and power | | | | | | | |
| Number of active | 1 at | 7 at | 1 at | 3 at | 3 at | 3 at | . . . |
| antennas on | relative | relative | relative | relative | relative | relative | |
| frequency 2 | power ½ | power 8/7 | power ½ | power 1 | power 1 | power 1 | |
| and power | | | | | | | |

An unequal power per active antenna can have benefits depending on the level of interference seen by users in this cluster and adjacent clusters, which influences within log( ) terms This level depends on the radiated power, distances, pathloss exponents, etc. Calculation of such interferences is something well known to those skilled in the art. Finding the best power patterns can be determined by a fine sampling of multiple patterns over the space of all possible patterns.

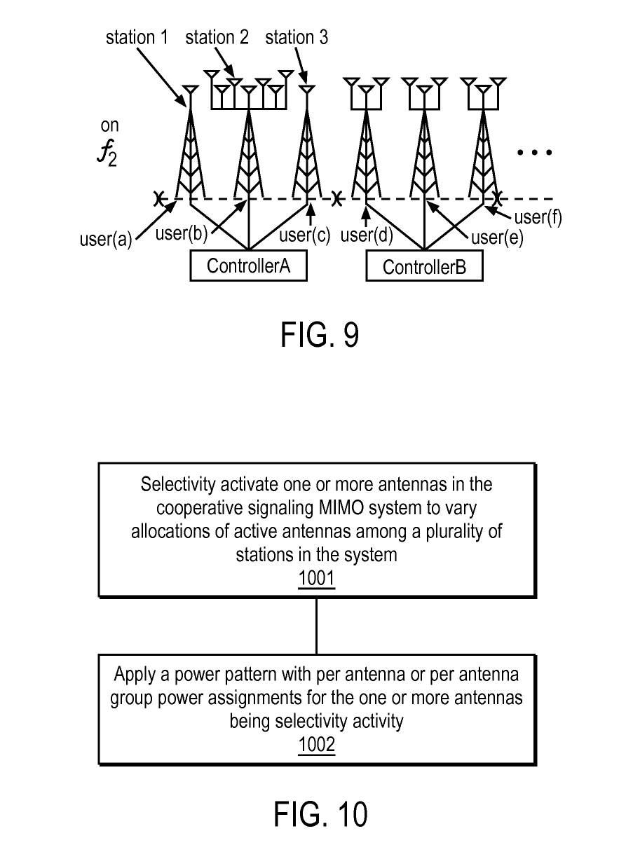

As an example of how power per antennas can be selected, consider the operation of a system with some representative users as in FIG. 9. Referring to FIG. 9, the focus is only at operation on one of the frequencies for which Station 1 has 1 active antenna, Station 2 has 7 active antennas an Station 3 has 1 active antenna. The analysis below has been simplified by considering 3 users, though the analysis generalizes to more.

Assume that the power allocations to stations (and their antennas) which are not in this cluster (not in cluster 1) are known. With this the nominal interference seen by some representative users, e.g. user(a), user(b), and user(c) on this frequency can be calculated (or estimated). For purposed herein, these interference levels are referred to as int(a), int(b) and int(c). One can also assume a reasonable value for int(a), int(b) and int(c) without an exact calculation or firm assumptions on stations outside the cluster.

Next assume the following:
i) user user(a) is served mainly by power radiated from Station 1; ii) User user(b) is served mainly by power radiated from Station 2; and iii) User user(c) is served mainly by power radiated from Station 3.

Though in a cooperative system signaling to any user can happen (and often has to happen) from all stations in the cluster, a prior mentioned simplification may be used which assumes that Station 1 only serves user(a), Station 2 only serves user(b), Station 3 only serves user(c), neglecting the lower cross terms which exist in jointly serving users, assuming they are small and correctly controlled for the purpose of interference control. In other words, the effective signal energy from, for example, Station 1 to user(b) is assumed at a first order negligible in the following analysis.

Assume, though only 3 users are illustrated, that there are many more users in the system. In fact, all that is really needed is to tie an interference level to a user, or equivalently a level to a number of users with an equivalent (in terms of interference) user location. Users such as user(a), with interference level int(a), can be served on this frequency a sum rate (very roughly) of the form

$${\sum }_{j = 1}^{M 1} log 2 ( 1 + P 1 / ( 1 + int ( a ) ) )$$

where M1 is the number of antennas on station 1 (M1=1), and P1 is the power per antenna on station 1 at this frequency (assuming that the pathloss to the user is 1; one can add pathloss into the formula, but for simplicity it is ignored here). We are assuming here that with M1 antennas we are able to serve M1 users. This is a good assumption under many MU-MIMO signaling schemes.

Similarly, users such as user(b), with interference level int(b), can be served on this frequency a sum rate (very roughly) of the form

$${\sum }_{j = 1}^{M 2} log 2 ( 1 + P 2 / ( 1 + int ( b ) ) )$$

where M2 is the number of antennas on station 2 (M2=7), and P2 is the power per antenna on station 2 at this frequency.

Similarly, users such as user(c), with interference level int(c), can be served on this frequency a sum rate (very roughly) of the form

$${\sum }_{j = 1}^{M 3} log 2 ( 1 + P 3 / ( 1 + int ( c ) ) )$$

where M3 is the number of antennas on station 3 (M3=1), and P3 is the power per antenna on station 3 at this frequency.

The above equations assume that locally the number of users served is proportional to the local number of active antennas, i.e. M1, M2, M3 as in the above summations, where the terms within the summations represent nominal per-user rates. This is often the case and a reasonable assumption in MU-MIMO systems,

To maximize a fair distribution of rate across the cluster, some function of such rates can be maximized. One such criterion is the sum log-(peruser-rate), given by:

M1×log 2(log 2(1+P1/(1+int(a)))+M2×log 2(log 2(1+P2/(1+int(b)))+M3×log 2(log 2(1+P3/(1+int(c)))

To do so, for a given M1, M2, M3, P1, P2 and P3 are selected. This is done by considering a (relative) constraint on the total power radiated across the cluster, e.g.

(M1×P1)+(M2×P2)+(M3×P3)=9.

The value 9 is just an example. The value in reality is tied to the total energy (power) allocated to the cluster at this frequency.

Using a Lagrange optimization of the sum log rate with respect to the constraint using a multiplier “λ”, the above optimization implies that P1, P2 and P3 are related in the following way:

log 2(1+P1/(1+int(a)))(1+P1/(1+int(a))(1+int(a))=λ

log 2(1+P2/(1+int(b)))(1+P2/(1+int(b))(1+int(b))=λ

log 2(1+P2/(1+int(c)))(1+P3/(1+int(c))(1+int(c))=λ

Here λ, is chosen so that the energy (power) constraint is met.

With this, one could solve for the P1, P2, P3 given M1, M2, M3, int(a), int(b), int(c) by using the appropriate λ. This solution would be a per-antenna power allocation that maximizes (roughly) the sum-log(per user rate) of the system considering users with similar signal and interference terms as user(a), user(b) and user(c).

An example, one solution in the case int(a)=int(b)=int(c) is in fact P1=P2=P3. That is the power per antenna is the same in all locations as described above in Table 5 above.

When int(a)≠int(b)≠int(c), which is generally the case, P1≠P2≠P3, and an unequal power per antenna may improve the objective criterion. This example (and the above calculation) shows that in general, there may be something to be gained by not having equal power per antenna. This would result in an embodiment with an additional power map as described say by Table 7 above.

In another embodiment, the relative powers P1, P2, P3 are known (say equal), and the system is designed by setting decide M1, M2, M3 to achieve interference levels int(a)=alpha, int(b)=beta and int(c)=gamma (or as close as possible since M1, M2 and M3 are restricted to being integers) under some constraint such as

M1+M2+M3=C.M

where “C” is the number of antenna locations and “M” is the average number of antennas per location.

Those skilled in the art can take the system in FIG. 9, assuming all odd clusters have the same antenna pattern [M1, M2, M3], and all even clusters have all the same antenna pattern [M4, M5, M6], calculate the resulting int(a), int(b) and int(c) given P1=P2=P3, and then set M1, M2, M3, M4, M5, M6, to achieve as close to the desired target interference levels alpha, beta and gamma. The solution is not necessarily unique unless there are also target interference levels in even clusters, say for users “d”, “e” and “f” in Cluster 2. This can of course be added in easily. Since M1, M2, M3, M4, M5 and M6 take values in a finite set, one can also exhaustively search for good combinations, evaluating the first-order capacity estimates of each as described above.

The system can be further refined by taking the solution M1, M2 and M3 and adjusting P1, P2, P3, given the choice of M1, M2, M3 . . . and so on, even iterating to a good joint solution.

However, even with some reasonable choices of M1, . . . , M6, and P1, . . . , P6, without considering the optimization above, choices of antenna allocations and powers can be found (using the aforementioned principles) that improve over the performance over simply M1=M2= . . . =M6=M, i.e. all the same active antennas per station, and P1=P2= . . . =P6=P, all the same power per antenna.

Note that one may consider adaptive changes to antenna activation and power patterns. For example, with changes in the distribution of active users in the system, one may also consider changes in the above equations. For example, if there are twice as many users under station 1 in FIG. 9, the above equations can be modified by including a second user(a) into the formulas and solving for new power and antenna patterns. Thus, patterns may be influenced adaptively by changes in user distributions and other changes in the network.

One can also consider power and activation patterns across a cooperative cluster in which possibly some stations are active, specifically at least two are active for at least one cluster in order that the idea of a cooperative cluster still holds. One such example is shown in Table 8 where clusters contain four cells, and in each cluster only two sites are active.

TABLE 8
A variable antenna activated system which changes across
frequency whereby some base-stations are inactive (have
zero active antennas) on some frequencies

| | Cluster | | | | | | | | |
|---|---|---|---|---|---|---|---|---|---|
| | CLUSTER 1 | | | | CLUSTER2 | | | | |
| Basestation | 1 | 2 | 3 | 4 | 5 | 6 | 7 | 8 | 9 |
| Number of active | 4 | 0 | 4 | 0 | 4 | 0 | 4 | 0 | . . . |
| antennas on | | | | | | | | | |
| frequency 1 | | | | | | | | | |
| Number of active | 0 | 4 | 0 | 4 | 0 | 4 | 0 | 4 | . . . |
| antennas on | | | | | | | | | |
| frequency 2 | | | | | | | | | |

In short, the above describes a number of techniques, including:
1. The concept of a variable allocation of active antennas to each station, across frequency and/or time (or any transmission resource unit), whereby each station has a pool or available antennas but only activates them in accordance with the allocation. A flow chart of one embodiment of this process is shown in FIG. 10.
2. The general types of some allocation/activation patterns, e.g. where some put more antennas towards the center of a cluster (or cell) and some put antennas more uniformly across space, and the patterns are distributed in a complementary fashion across transmission resources to achieve interference targets.
3. Ways to optimize such patterns by choosing the number of antennas to achieve target rates or interference levels.
4. A method to also associate a power per antenna levels for each antenna on each allocation (and time and/or frequency).
5. Ways to optimize such power levels to achieve target rates or interference levels.

### Antenna Single Port Coordination

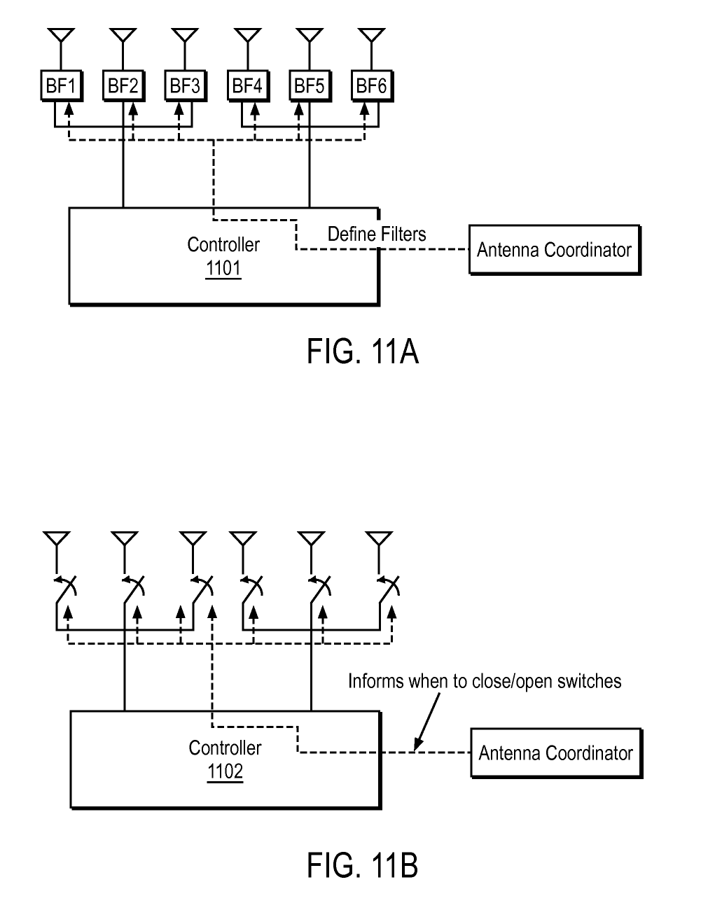

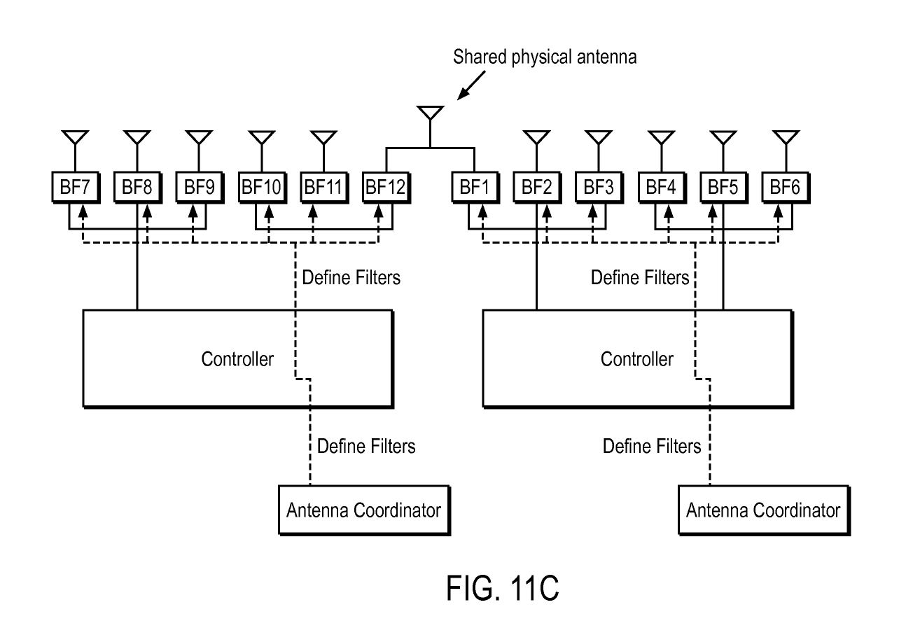

FIGS. 11A and 11B illustrate two techniques by which a controller can drive a group of antennas. Note that these are only two examples and that there are other well-known ways in which to control antennas that may be used with the embodiments described herein.

Referring to FIG. 11A, controller 1101 drives a signal with multiple bands through one antenna port. That is, controller 1101 uses a single port to drive 3 antennas over three different bands. The signal is received by multiple antennas, which each have a bandpass filter, filters illustrated by Bf₁, Bf₂, Bf₃ that filters a different band of the signal, i.e. passes only one of the three bands. The filters may be defined by an antenna coordinator that provides information regarding the filters to controller 1101. Each filter passes the band that drives its corresponding antenna. If such bands do not overlap, the implicit result is that different antennas are active on different frequencies. If some bands overlap, multiple antennas can be active when the bands of their respective filters overlap. Filters can also include gains, which then directly specify the relative power level driving the antenna. Note that although only three antennas are shown, there may be more or less antennas. Also, the antennas may be at the same or different stations.

FIG. 11B is an alternative arrangement in which multiple antennas are driven by controller 1102 through a single port. However, in this instance, a time switch 1103 is used to cause different antennas to be driven at different times. An antenna coordinator provides information and/or signals to inform when to close/open switches.

FIG. 11C illustrates a physical antenna shared by two separate controllers with separate antenna coordinators defining filters, two of which are used to drive the shared physical antenna.

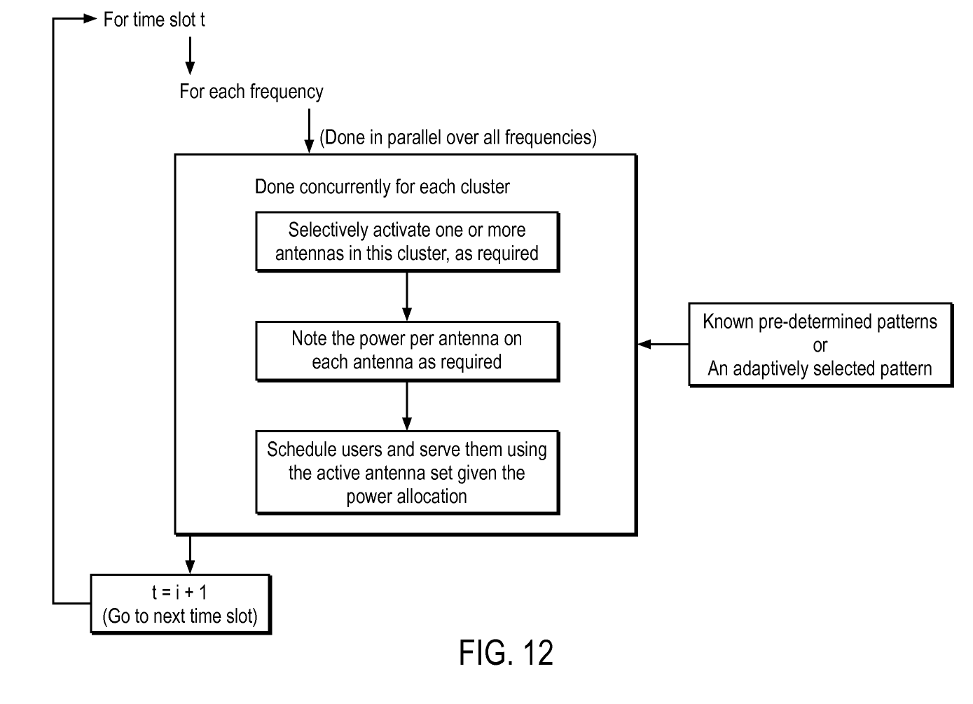

FIG. 12 illustrates that antenna and power patterns are implemented at each cooperative cluster, such cluster definitions themselves which may vary in time and/or frequency. For each such cluster, at each time (e.g., time slot t) and frequency, an antenna pattern and power assignment is implemented to service users. Specifically, as shown in FIG. 12, for each cluster, a controller selectively activates one or more antennas in this cluster, as required; notes the power per antenna on each antenna as required; and schedules users and severs them using the active antenna set given the power allocation. Such patterns and assignments can be pre-determined. This allows controllers for each cluster to simply implement the scheme in FIG. 10 in a known pre-determined fashion. If the patterns and assignments can adapt, such adaptation is determined by an entity which communicates the assignments to be used at each cluster controller.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

I claim:

1. A method for use in a cooperative signaling MIMO system in which antennas are located a plurality of different locations across a geographic area, the system comprising a plurality of different cooperative MIMO controllers and a plurality of antennas that can be communicably coupled to each of the controllers, the method comprising:
at different transmission instances, selectively activating one or more antennas in the cooperative signaling MIMO system to vary which subset of antennas are active among antennas that can be used for each of the controllers in the system,
including applying a power pattern which specifies per antenna or per antenna group power assignments for the one or more antennas being selectively activated,
and performing cooperative MIMO transmission under control of each controller in conformance with antenna activation and antenna power assignments assigned for each transmission time.

2. The method defined in claim 1 wherein selectively activating the one or more antennas comprises switching between the different allocations over one or both of time and frequency.

3. The method defined in claim 1 further comprising changing the power pattern over one or both of time and frequency.

4. The method defined in claim 3 wherein the power pattern is changed to cause antennas of a given controller at two or more geographic locations to use different power levels at different times or frequencies.

5. The method defined in claim 1 wherein the power pattern specifies that, for a group of antennas associated with a controller, one subset of active antennas is using proportionately less power per antenna than another subset of active antennas.

6. The method defined in claim 1 wherein the power level per active antenna and antenna activation pattern can be different for different groups of antennas which are active on the same time and frequency, each of the different groups being associated with a controller.

7. The method defined in claim 1 wherein the power level per antenna for each antenna in each allocation varies frequency to frequency or time slot to time slot.

8. The method defined in claim 1 wherein selectively activating one or more antennas in the cooperative signaling MIMO system comprises coordinating selective activation of the plurality of antenna groups to have complementary antenna activation patterns occur across clusters of controllers, such that the cooperative signaling MIMO system operates as an overlapped antenna set system in which controllers share physical antennas but activate them on different time and or frequency resources.

9. The method defined in claim 1 further comprising assigning patterns so that each controller sees each pattern in a pre-determined sequence.

10. The method defined in claim 1 wherein selectively activating one or more antennas causes at least two different patterns of antennas to be activated at different times, where each of the at least different patterns specifies which in a number of antennas to be active at each controller and the power of each active antenna in the cluster.

11. The method defined in claim 10 wherein, for each controller and associated plurality of antennas, antennas located at a plurality of locations, a first pattern specifies which of a number of antennas is active at each location on a first frequency with a power level for each antenna and a second pattern specifies which of a second number of active antennas is active at each location on a second frequency and a power level for each antenna.

12. The method defined in claim 11 wherein more than two frequencies may be used.

13. The method defined in claim 1 wherein antenna activation varies across at least the geographic area covered by antennas of one controller such that areas near the edge of the geographic see both large numbers of antennas and favorable interference conditions at least one some time or frequency slots.

14. The method defined in claim 1 further comprising adapting power assignments in the power pattern and allocations of active antennas being activated.

15. The method defined in claim 1 wherein, for each cluster, antennas on a first set of at least two sites are all active on a first frequency and a second set of sites different than the first set of sites are all active on a second frequency different than the first frequency.

16. A cooperative signaling MIMO system comprising:
a plurality of cooperative controllers, wherein each of the plurality of controllers has a set of antennas and each antenna in the set is selectively activated in accordance with an allocation that varies over one or both of time and frequency, and
wherein each controller includes a coordinator to selectively activate or deactivate each antenna.

17. The system defined in claim 16 wherein selectively activating the one or more antennas comprises switching between the allocations over one or both of time and frequency.

18. The system defined in claim 16 wherein the method further comprises changing the power pattern over one or both of time and frequency.

19. The system defined in claim 16 wherein selectively activating one or more antennas causes at least two different patterns of antennas to be activated at different times, such that, for a set of antennas associated with a controller, the antennas being located at a plurality of geographic locations, a first pattern specifies a number of active antennas at each location on a first frequency and a power level for each location of active antennas and a second pattern specifies a second number of active antennas on a second frequency and a power level for each location's antennas.

20. The system defined in claim 16 further comprising a system controller to control selective activation performed by a plurality of coordinators in the system, each of the coordinators controlling the activation of the plurality of sets of antennas each associated with one of a plurality of controllers in a cluster.

21. The system defined in claim 16 wherein the coordinator is operable to selectively activate or deactivate each associated antenna, wherein deactivating is achieved by either driving an antenna with a zero-input signal or shutting down an antenna.

22. The system defined in claim 16 wherein the coordinator is operable to adapt power assignments in the power pattern and allocations of active antennas being activated

23. The system defined in claim 16 wherein, for each cluster, antennas on a first set of at least two sites are all active on a first frequency and a second set of sites different than the first set of sites are all active on a second frequency different than the first frequency.

24. An article of manufacture having one or more computer readable storage medium storing instructions which, when executed by one or more controllers cause the one or more controllers to perform a method for use in a cooperative signaling MIMO system in which antennas are located a plurality of different locations across a geographic area, the system comprising a plurality of different cooperative MIMO controllers and a plurality of antennas that can be communicably coupled to each of the controllers, the method comprising:
at different transmission times, selectively activating one or more antennas in the cooperative signaling MIMO system to vary which antennas are active antennas among antennas that can be used for each of the controllers in the system,
including applying a power pattern which specifies per antenna or per antenna group power assignments for the one or more antennas being selectively activated,
and performing cooperative MIMO transmission under control of each controller in conformance with antenna activation and antenna power assignments assigned for each transmission time.
